(19) United States
(12) Patent Application Publication
(10) Pub. No.: US 2014/0214469 A1
(43) Pub. Date: Jul. 31, 2014

(54) GOAL-BASED PLANNING SYSTEM

(71) Applicants: Glenn Michael Callow, Cottesloe (AU); Markus Deittert, Stoke Gifford (GB); John Paterson Bookless, Bristol (GB)

(72) Inventors: Glenn Michael Callow, Cottesloe (AU); Markus Deittert, Stoke Gifford (GB); John Paterson Bookless, Bristol (GB)

(73) Assignee: BAE SYSTEMS PLC, London (GB)

(21) Appl. No.: 14/240,907

(22) PCT Filed: Aug. 22, 2012
(86) PCT No.: PCT/GB2012/052049

§ 371 Date: Feb. 25, 2014

(30) Foreign Application Priority Data
Aug. 26, 2011 (GB) 1114815.2

(51) Int. Cl. G06Q 10/06

(52) U.S. Cl. CPC G06Q 10/063114
USPC 705/7.15

(57) ABSTRACT

Methods and apparatus for determining actions to be performed by a plurality of assets such that a predetermined task is performed. Methods comprise receiving, by a task decomposition module (105), task information that specifies the predetermined task; using the task information, determining, by the task decomposition module (105), a plurality of sub-tasks, the sub-tasks being such that if each of those sub-tasks were performed, the predetermined task would be performed; using information relating to the plurality of assets and the determined sub-tasks, assigning, by an assignment module (115), each sub-task to an asset; for each asset to which a sub-task has been assigned, and for each sub-task assigned to that asset, determining, by a planner module (120), one or more actions, an action determined for an asset and sub-task being such that, if that action is performed by that asset, that sub-task is performed.

### FIELD OF THE INVENTION

The present invention relates to methods and apparatus for goal-based planning and control of multi-asset systems.

### BACKGROUND

It is known to provide control systems for autonomous assets in which the implementation of the control system is largely bespoke to a particular application and the corresponding objectives to be achieved. Algorithms, each designed to achieve specific objectives, are integrated to form an overall control system, for example one directed to mission planning or to automated warehouse control.

### SUMMARY OF THE INVENTION

In a first aspect the present invention provides a method of determining actions to be performed by a plurality of assets such that a predetermined task is performed, the method comprising: receiving, by one or more task decomposition modules, task information, the task information specifying the predetermined task that is to be performed by the plurality of assets; using the task information, determining, by the one or more task decomposition modules, a plurality of sub-tasks, the plurality of sub-tasks being such that if each of those sub-tasks were performed, the task specified by the task information would be performed; using information relating to the plurality of assets and the determined sub-tasks, assigning, by one or more assignment modules, each of the sub-tasks to an asset; for each asset to which a sub-task has been assigned, and for each sub-task assigned to that asset, determining, at least in part by one or more planner modules, one or more actions; wherein the one or more actions determined for an asset and for a sub-task assigned to that asset are such that, if those actions are performed by that asset, that asset would perform that sub-task.

The method may further comprise, for each asset to which a sub-task has been assigned, controlling, by one or more execution modules, that asset depending upon the one or more actions determined for that asset.

Each of the assets may comprise a respective execution module. For each asset to which a sub-task has been assigned, the execution module of that asset may control that asset depending upon the one or more actions determined for that asset.

The controlling of an asset may be performed such that that asset performs each of the actions that have been determined for it.

The method may further comprise, performing, by each of the assets to which a sub-task has been assigned, the sub-tasks that have been assigned to that asset.

An algorithm implemented by a module may be independent from an algorithm performed by a different type of module. An algorithm implemented by a module may be a standard or open algorithm.

Interfaces between different types of modules may be fixed or standard interfaces.

Each of the assets may comprise a respective assignment module.

The step of assigning may comprise, for each asset, the assignment module of that asset identifying, depending upon one or more capabilities of that asset, one or more of the sub-tasks for assignment to that asset.

The step of assigning may further comprise one or more communications being sent between two different task assignment modules to negotiate which sub-tasks are assigned to which asset.

Each of the assets may comprise a respective task decomposition module. Also, each of the task decomposition modules may perform the same task decomposition process as each of the other task decomposition modules such that the plurality of sub-tasks determined by each of the task decomposition modules is the same as the plurality of sub-tasks determined by each of the other task decomposition modules.

Each of the assets may comprise a respective planner module. Also, for each asset to which a sub-task has been assigned, the planner module of that asset may determine, for each sub-task assigned to that asset, one or more actions, the one or more actions being such that were those actions to be performed by that asset, that asset would perform that sub-task.

The step of determining one or more actions may comprise performing, at least in part by one or more deconflictor modules, a deconfliction process to remove conflicts or inconsistencies between determined actions.

Each of the assets may comprise a respective deconflictor module. Also, the step of determining one or more actions may comprise one or more communications being sent between two different deconflictor modules to negotiate which actions to modify so as to remove conflicts or inconsistencies between those actions.

The method may further comprise determining, by a state estimator module, current state information for each of the assets. Also, one or more of the steps of determining the plurality of sub-tasks, assigning each of the sub-tasks to an asset, and determining one or more actions may comprise using some or all of the determined state information.

In a further aspect, the present invention provides a system for determining actions to be performed by a plurality of assets such that a predetermined task is performed, the system comprising: one or more task decomposition modules, each task decomposition module configured to: receive task information, the task information specifying the predetermined task that is to be performed by the plurality of assets; and using the task information, determine a plurality of sub-tasks, the plurality of sub-tasks being such that if each of those sub-tasks were performed, the task specified by the task information would be performed; one or more assignment modules, each assignment module being configured to, using information relating to the plurality of assets and the determined sub-tasks, assign each of the sub-tasks to an asset; one or more planner modules, each planner module being configured to, at least in part, determine, for each asset to which a sub-task has been assigned, and for each sub-task assigned to that asset, one or more actions; wherein the one or more actions determined for an asset and for a sub-task assigned to that asset are such that if those actions are performed by that asset, that asset would perform that sub-task.

In a further aspect, the present invention provides a computer program or plurality of computer programs arranged such that when executed by a computer system it/they cause the computer system to operate in accordance with the method of any of the above aspects.

In a further aspect, the present invention provides a machine readable storage medium storing a computer program or at least one of the plurality of computer programs according to the above aspect.

### BRIEF DESCRIPTION OF THE DRAWINGS

FIG. 1 is a schematic illustration (not to scale) showing two assets, each asset comprising modules of a goal-based planning framework;

FIG. 2 is a schematic illustration (not to scale) showing information flow between modules of the goal-based planning framework;

FIG. 3 is a process flow chart showing certain steps of a process that may be performed by a Task Manager module of the goal-based planning framework;

FIG. 4 is a schematic illustration (not to scale) showing the interfaces that may be used between a Coordinator module of the goal-based planning framework and other modules module of the goal-based planning framework

FIG. 5 is an activity diagram showing functional activity occurring during a process of decomposing a goal into a list of tasks;

FIG. 6 is an activity diagram showing functional activity occurring during a task assignment process;

FIG. 7 is an activity diagram showing functional activity occurring during a process of computing a plan for an individual task;

FIG. 8 is an activity diagram showing functional activity occurring during a process of executing a generated plan;

FIG. 9 is an activity diagram showing functional activity occurring during a process of handling of communication messages sent between assets;

FIG. 10 is a process flow chart showing certain steps of a process that may be performed by a Goal Decomposition module of the goal-based planning framework;

FIG. 11 is a schematic illustration (not to scale) showing example input and output files for the Goal Decomposition module;

FIG. 12 is a process flow chart showing certain steps of a process that may be performed by an Automated Planner module of the goal-based planning framework;

FIG. 13 is a schematic illustration (not to scale) showing example input files for the Automated Planner module; and

FIG. 14 is a schematic illustration (not to scale) showing an example of a state model stored by a State Estimator module of the goal-based planning framework.

### DETAILED DESCRIPTION

This invention relates to methods and apparatus for goal-based planning and control of multi-asset systems. In particular, but not exclusively, this invention provides a modular control system framework for distributed operation across multiple autonomous assets working towards the achievement of one or more common objectives, supporting centralised, distributed and fully-decentralised variants.

In the present invention, a generic control system framework has been devised to support collaboration between multiple software agents, including negotiation and on-board automated planning to achieve goals (or tasks) assigned to a team of at least partially autonomous assets. Advantageously, an operator will have the ability to control large teams of autonomous assets each of which have an independent version of this generic control system framework running on-board.

Apparatus for implementing the below described arrangements, and performing the below described method steps may be provided by configuring or adapting any suitable apparatus, for example one or more computers or other processing apparatus or processors, and/or providing additional modules. The apparatus may comprise a computer, a network of computers, or one or more processors, for implementing instructions and using data, including instructions and data in the form of a computer program or plurality of computer programs stored in or on a machine readable storage medium such as computer memory, a computer disk, ROM, PROM etc., or any combination of these or other storage media.

It should be noted that certain of the process steps depicted in the below described flowcharts may be omitted or such process steps may be performed in differing order to that presented herein and shown in the Figures. Furthermore, although all the process steps have, for convenience and ease of understanding, been depicted as discrete temporally-sequential steps, nevertheless some of the process steps may in fact be performed simultaneously or at least overlapping to some extent temporally.

The framework of the present invention provides each asset within a team of assets with the following capabilities:

a) an ability to decompose high-level goals (or tasks) into an available list of tasks which can be handled by the asset;

b) an ability to select tasks from the available list which best utilise the asset's capabilities and to collaborate with other assets in the team to agree on preferred team task assignments;

c) an ability to generate a plan autonomously for the implementation of each task assigned to the asset, given knowledge of a “world state” and a desired “goal state”;

d) an ability to identify and resolve conflicts which exist in generated plans between assets by sharing plan steps and assessing what changes may be made to resolve the identified conflicts; and

e) an ability to communicate with other assets in the team to share a common operating picture and to negotiate over plans and tasks.

With sharing of state information, the present invention may also support planning in systems where both manned and unmanned equipment are working in collaboration to achieve goals.

Rather than providing a bespoke control system solution directed to a particular application with an integrated set of fixed algorithms selected at the design phase, the methods and apparatus described herein tends to provide a modular design with a set of fixed interfaces between modules and enabling “plug-and-play” development of underlying algorithms. In other words, algorithms used by one type of module may be independent from those used by different types of modules, whilst the interfaces between the different types of modules may be fixed interfaces. The methods and apparatus described herein also tend to provide a planning test-bed that enables combinations of goal-decomposition (or task-decomposition), task assignment, automated planning and plan deconfliction algorithms to be evaluated and validated e.g. before implementation in an operational environment. Such evaluation and validation may include exercising of the functionality intended for operational use in order to satisfy official certification bodies regarding public safety, etc. The methods and apparatus described herein also tends to enable performance metrics to be collected, for example relating to communications bandwidth, processor loads and plan quality metrics. By defining a set of test scenarios and gathering performance metrics, comparisons can be made between different types of algorithms which support planning, for example. The generic framework of the present invention would be expected to provide means for raising the technology readiness level of candidate algorithms as they are produced, for example by academic research groups, and maturing them until they reach a level suitable for deployment on real platforms. The methods and apparatus described herein also tend to be suitable for performing Monte-Carlo comparison of integrated algorithms and collecting performance metrics over a large number of runs to raise confidence in the algorithm performance against a pre-defined scenario.

The framework according to the present invention aims to be generic, allowing it to be adapted to numerous types of multi-agent planning problem. Two example scenarios to which preferred embodiments of the present invention may be applied are: a search and rescue scenario where an operator, e.g. a Coast Guard, has tasked a team of assets to search an area of sea for survivors of a boating accident; and a logistics planning problem where the operator has tasked a team of autonomous forklift vehicles to pack shelves in a factory or warehouse. A version of the generic control system framework of the present invention would run on-board every asset in each of these scenarios. The underlying algorithms are applicable in both of these scenarios, enabling cooperation between team members to achieve goals assigned by an operator. The types of sub-task that may be performed to complete the goals in each scenario would be differently defined within the framework according to a defined list of asset capabilities. The content of a state model would also be tailored to the respective scenarios.

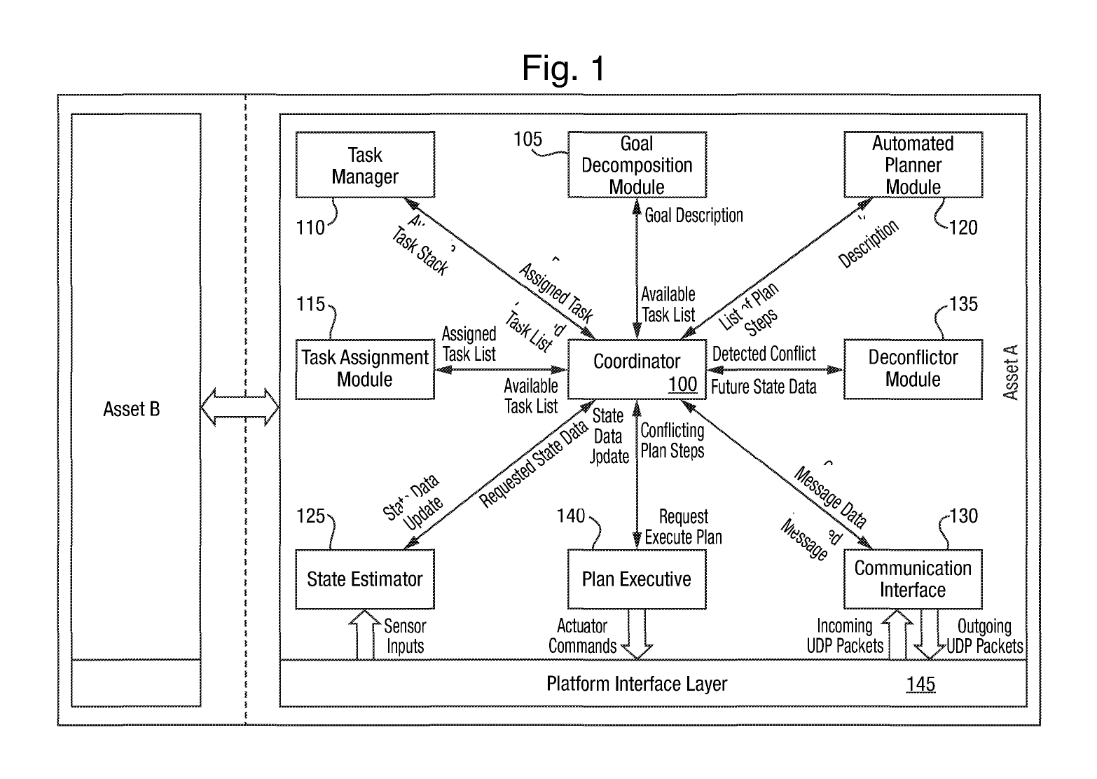

Referring to FIG. 1, a preferred embodiment of a generic goal-based planning framework is shown as would be deployed and operational within each participating asset within a team of assets. Two assets—Asset A and Asset B—are shown in FIG. 1, but a team may comprise many assets of the same or of mixed types, each implementing a version of the framework.

In the preferred framework of FIG. 1, a Coordinator module 100 is arranged to invoke any one of a set of modules comprised in the framework and provides a central data exchange between those modules. In the present invention, the Coordinator module 100 provides an interface (which the surrounding modules 105-140 support) composed of services and events. The Coordinator module 100 may pass input data into a surrounding module 105-140 via a service and trigger the functionality of that module 105-140. Once a surrounding module 105-140 has computed a result, an event will pass this information back to the Coordinator module 100 where it will then trigger the next process in the planning sequence. The Coordinator module 100 is responsible for handling any error information passed back from a surrounding module 105-140 or any computation timeouts during module execution.

The functionality of each in this set of modules will be described in more detail below but, in summary, the set of modules preferably comprise:

a Goal Decomposition module 105, arranged to receive a Goal Description listing all goals to be achieved. The goals are stored in a “goal stack” and incorporated into a problem definition script. This will invoke a planner used to carry out a decomposition of that goal into a set of tasks to be performed by the team of assets;

a Task Manager module 110, arranged to maintain a task stack, created or updated in particular as a result of a goal decomposition by the Goal Decomposition module 105;

a Task Assignment module 115, arranged to compute assignments of available tasks (or sub-tasks) held in the task stack for each asset in the team of assets;

an Automated Planning module which will incorporate a Planning Domain Definition Language (PDDL) Planner 120 or suitable alternative, arranged to compute plans, given initial and goal state data, to enable completion of tasks assigned to an asset by the Task Assignment module 115;

a State Estimator module 125, arranged with access to sensor data within the asset and to data received from other assets to maintain a problem-specific state model;

a Communication module 130, arranged to provide a communications interface to other assets. This module can also receive input high-level goals from an operator or planning configuration information such as a priori known data or constraints relating to the planning environment;

a Deconfliction module 135, arranged to share plans generated by the Automated Planner module 120 with other assets and to implement a negotiation algorithm for the deconfliction of plans as the need arises; and

a Plan Executive 140, arranged to control the execution of actions in a deconflicted plan by the asset.

The framework also includes a Platform Interface Layer 145 designed to provide a set of interfaces (e.g. a standard set of interfaces as opposed to bespoke interfaces) to enable the modules 100-140 to interact with sensors, actuators, communications hardware or other devices installed within or accessible to the asset. This layer may provide interfaces for direct communication with sensor and actuator hardware on a platform, but may also provide functionality to interact with a behaviour based planner responsible for the low-level operation of the asset. This layer may also be interfaced with appropriate simulators when performing goal-based planning in a synthetic environment.

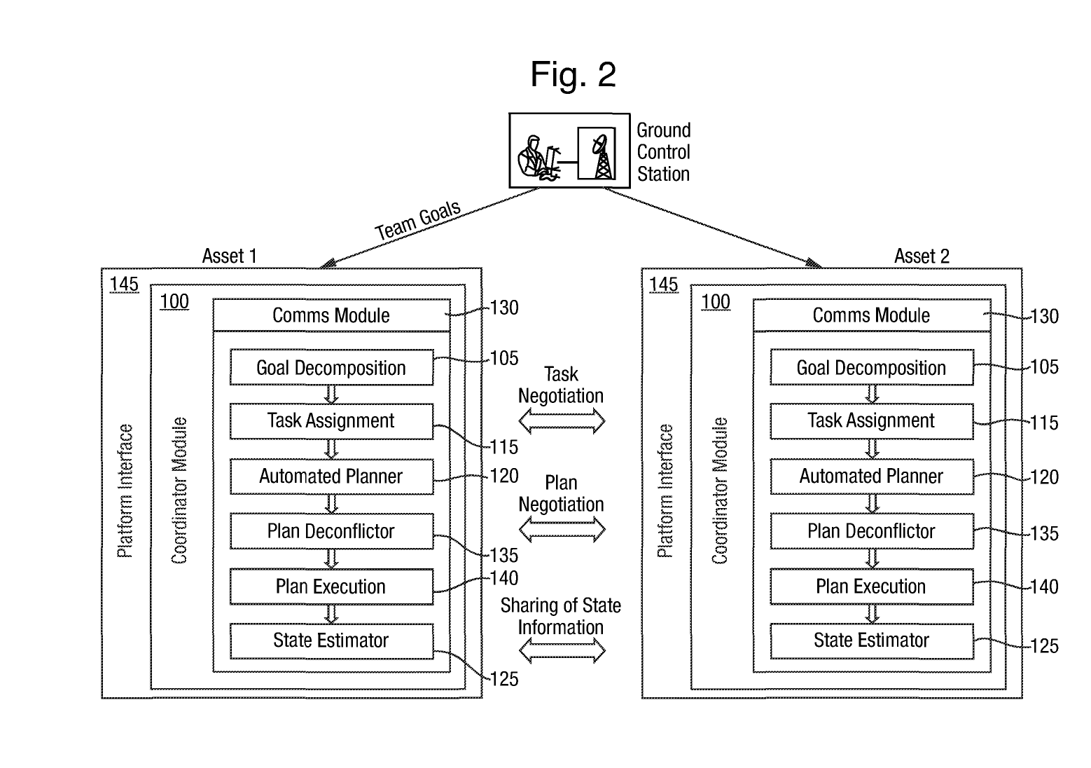

A preferred information flow between the modules 100-140 in the control system framework summarised above will now be described with reference to FIG. 2.

Referring to FIG. 2, at a low-level, all interaction between modules occurs via the Coordinator module 100 which provides a set of service functions and event handlers to monitor the operations of (and may pass data between) the other modules 105-140. Preferred information flow occurs in a sequence as follows:

(i) Incoming messages are processed by the Communications (“Comms”) Module 130 and an event is generated which passes relevant messages to the Coordinator 100. The types of message that are handled include updates to a state model (as maintained by the State Estimator 125) from an external source, updates to a goal stack and requests to perform a re-plan.

(ii) When an update to the goal-stack is requested, for example the addition of a new goal or an amendment to an existing goal, the Coordinator 100 invokes the Goal Decomposition module 105 which decomposes the new goal into a list of low-level tasks to create or update an “available tasks” stack. Once goal decomposition is complete, an event is generated which passes the new or updated available task stack to the Coordinator 100.

(iii) The Coordinator 100 then invokes the Task Assignment module 115 and passes the Available Task stack to it, along with relevant state information provided by the State Estimator 125. The Task Assignment module 115 will then compute an Assigned Task list for the platform indicating which tasks are best suited to the asset's capabilities. This process may require some negotiation with other assets depending on the type of algorithm that is applied.

(iv) Once an Assigned Task list is available, the Task Assignment Module 115 will pass this information, via an event, to the Coordinator 100. The Coordinator 100 then invokes the Automated Planner module 120 which will compute a list of actions that the asset, or the team of assets, will need to execute to achieve the assigned tasks. Responsibilities may also include computing a route for an asset to follow between that asset's tasks e.g. while also ensuring that the planning constraints such as task completion time are achieved. While one of the known PDDL-based automated planners is suitable for use in this module as a generic means of expressing planning problems, other types of automated planner may be used alternatively, including a more basic router.

(v) When the Automated Planner module 120 has completed, an event will pass the resultant plan onto the Coordinator module 100 to update the state information. Once each asset with the team has a plan available, the Coordinator 100 will invoke the Plan Deconflictor module 135. This module may attempt to identify any conflicts between the plans generated by assets. This module may also attempt to modify one or more plans to remove any conflicts between assets/plans.

(vi) Once a set of deconflicted plans are available for each asset, the Coordinator 100 will invoke the Plan Execution module 140. As the plan executes, updates are made via the Coordinator 100 to the State Estimator 125 with information about the environment model and the other asset positions. The information is shared around the team of assets, e.g. via the Communication module 130, to maintain up to date state models at each asset.

A more detailed description will now be provided for each of the modules 100-140 introduced above. One particular benefit of the modular architectural design of the present invention is that new versions of each of these modules may be implemented and easily integrated within the framework e.g. by implementing the standard interface (e.g. by implementing the standard function calls) as provided by the Coordinator module 100.

Task Manager 110

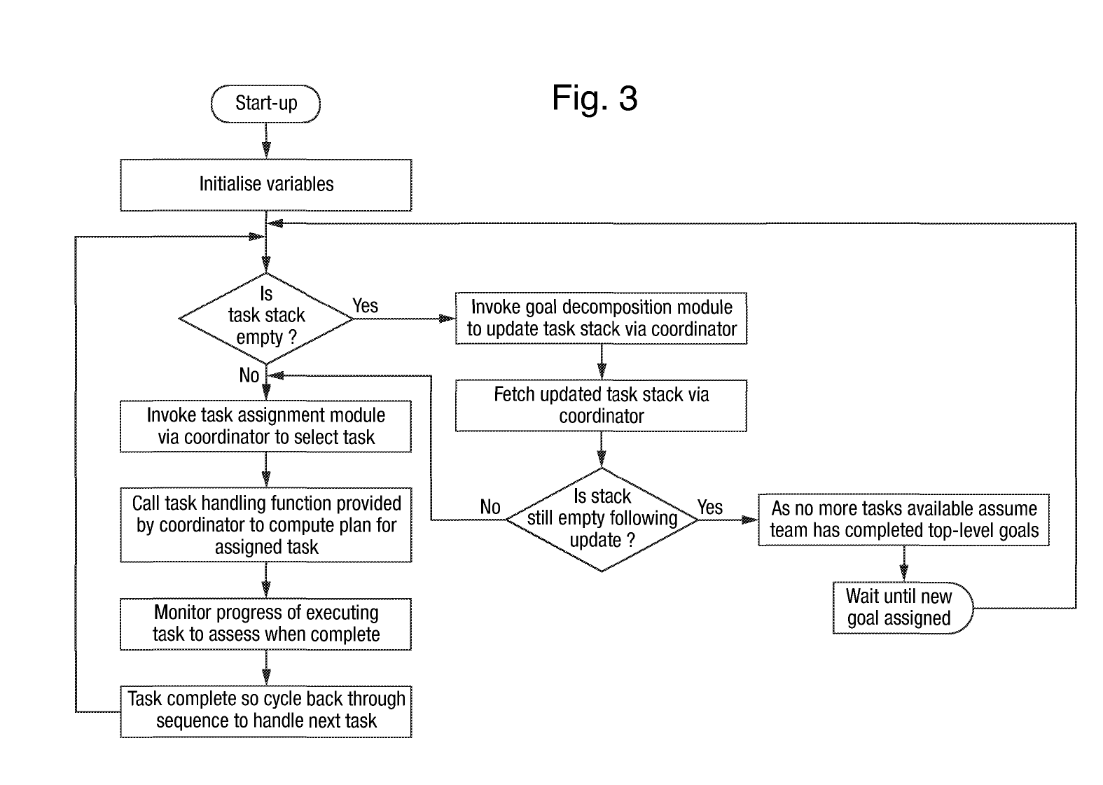

A flow chart outlining preferred functionality of the Task Manager 110 is shown in FIG. 3. Referring to FIG. 3, the Task Manager 110 maintains a task stack which is computed by the goal decomposition module 105. When the task stack is empty the goal decomposition module 115 is invoked to compute a list of tasks (or sub-goals) that may be performed to complete assigned team goals. When the goal decomposition module 115 no longer outputs a list of tasks the asset can assume all goals are complete. In this case, the task manager 110 will go into a wait state listening until an operator assigns new goals to the team.

Coordinator Module 100

The Coordinator module 100 is the central hub of the control system framework, supporting all interactions between the modules 105-140. The Coordinator 100 provides a well defined set of interfaces making it easier to integrate updated modules into the framework without having an impact on the operations of the other modules.

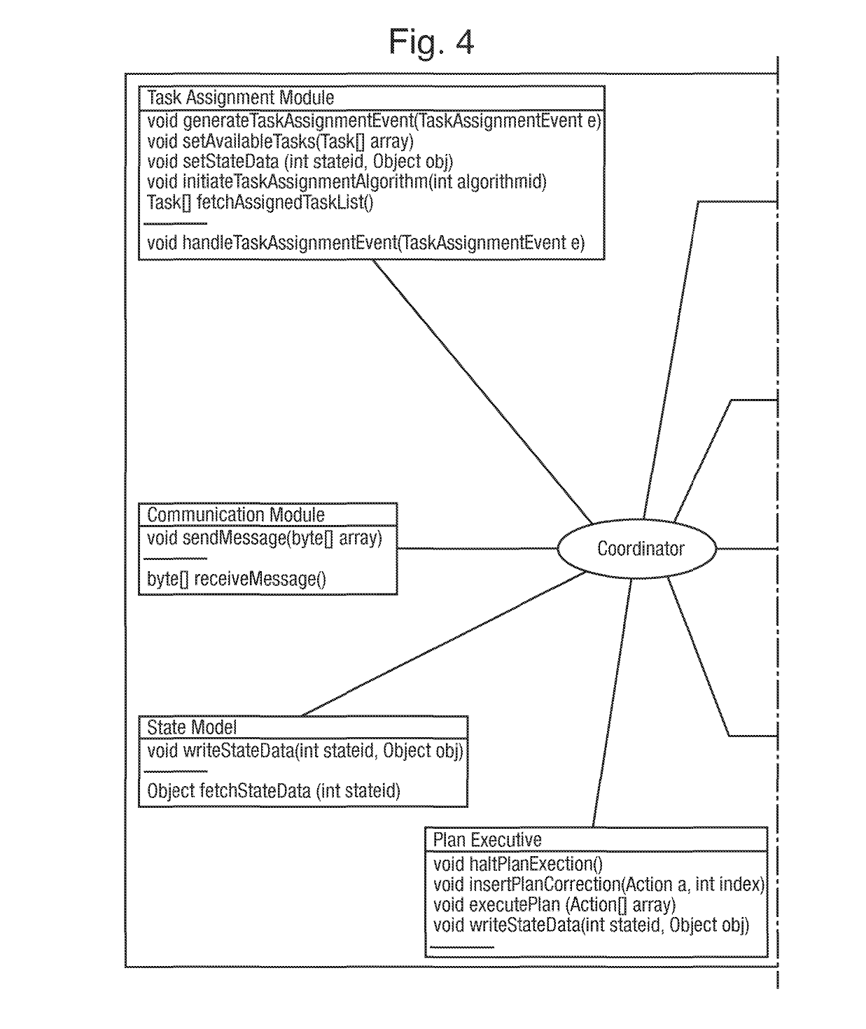

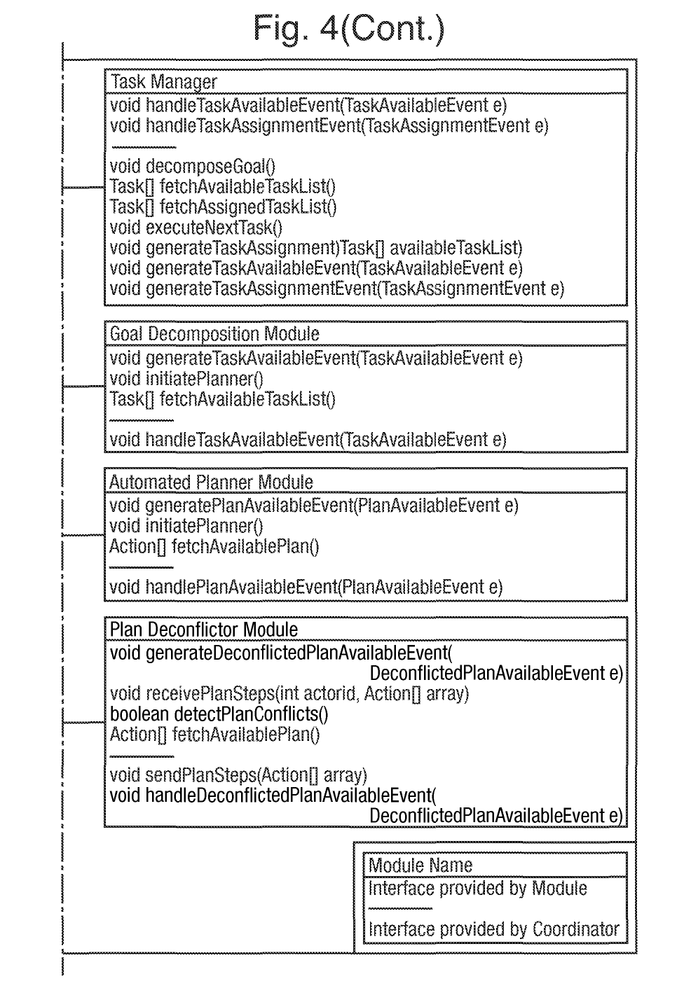

Referring to FIG. 4, a diagram is provided that shows example interfaces between the Coordinator module 100 and the surrounding modules 105-140. In the subsequent FIGS. 5 to 9, a series of activity diagrams are also provided which describe example functional activity occurring during key events such as:

Decomposing a goal into a list of tasks (see FIG. 5)

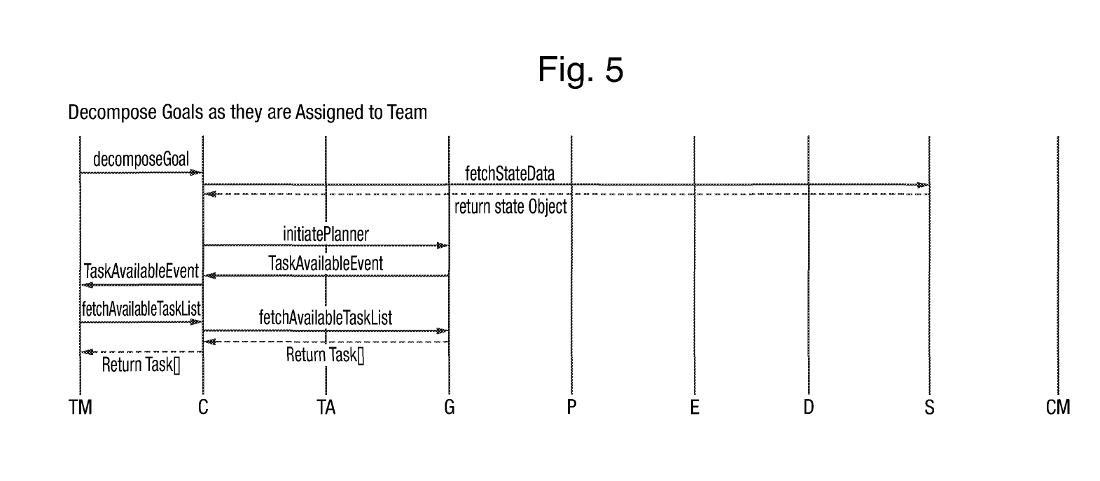

Task assignment process (see FIG. 6)

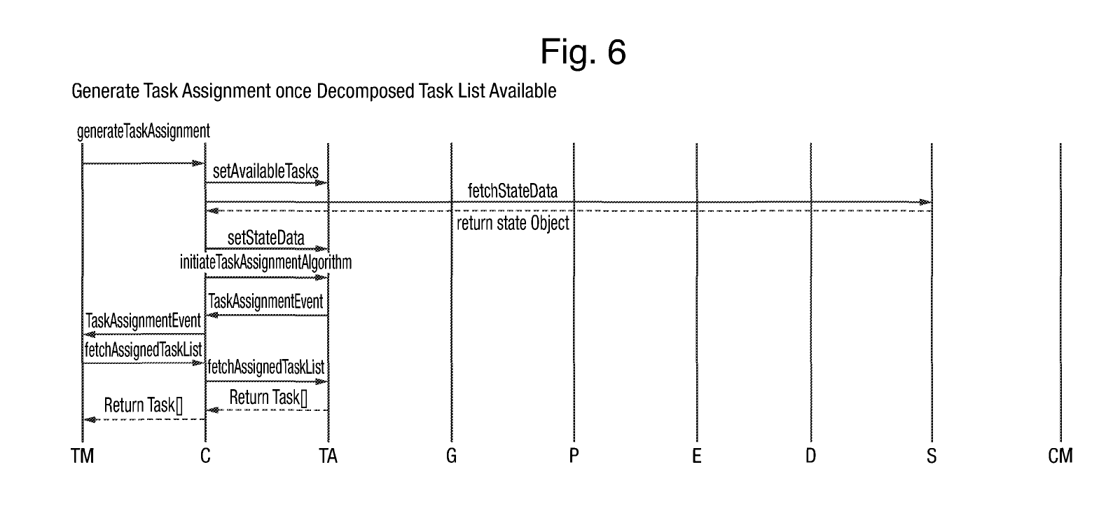

Computing a plan for an individual task (see FIG. 7)

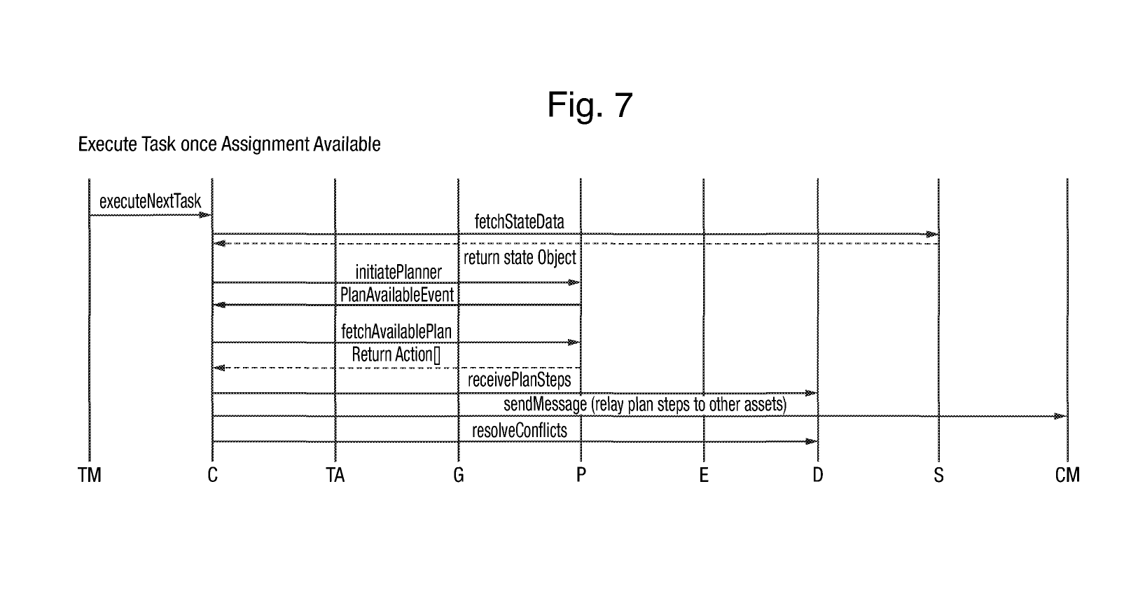

Executing a generated plan (see FIG. 8)

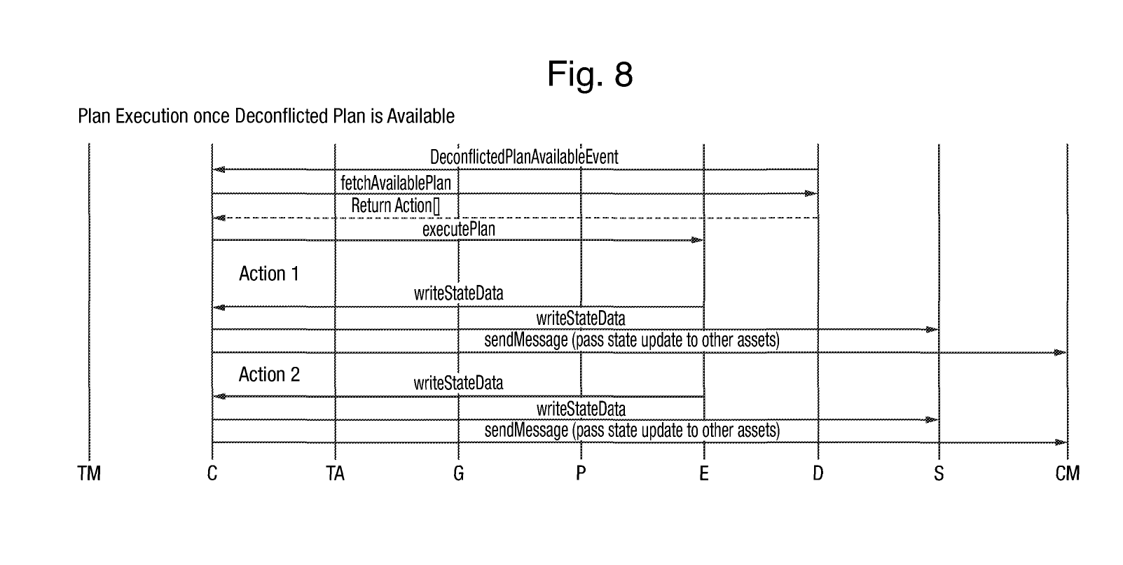

Handling of communication messages received from other assets (see FIG. 9)

Goal Decomposition Module 105

The Goal Decomposition module 105 is invoked by the Coordinator 100 either as a request from the Task Manager 110 to update the task stack, or as the result of an event which requires additional tasks to be added (for example a change in the available state information by the State Estimator 125 may require additional tasks to be handled before the assigned goal is completed).

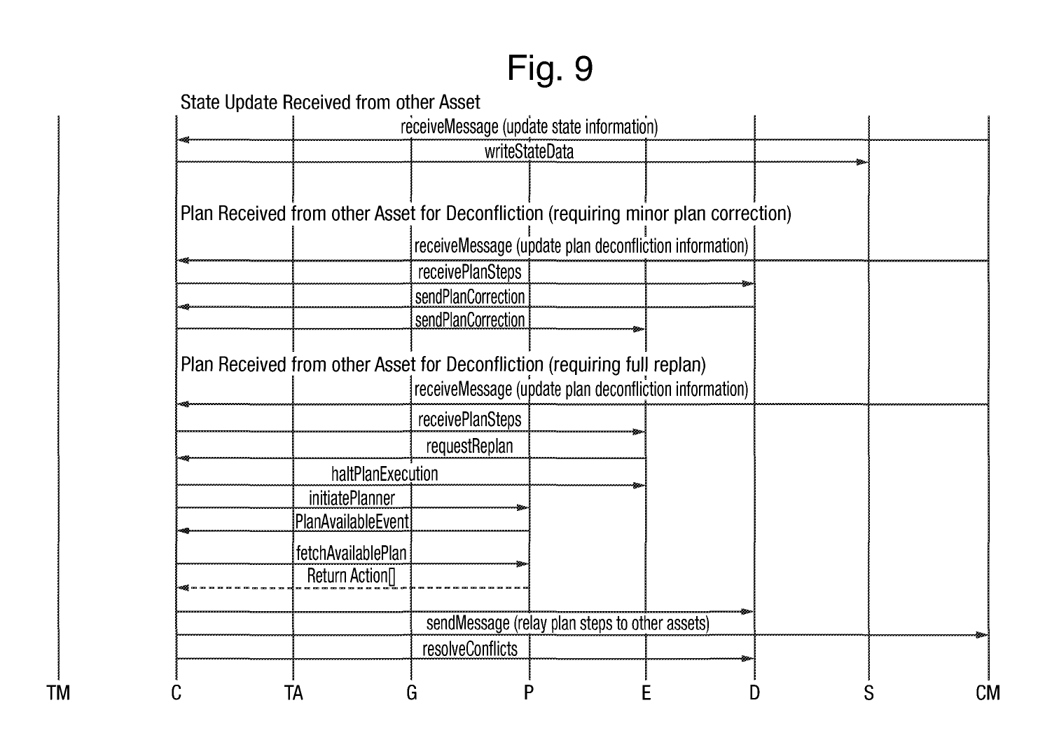

Referring to FIG. 10, a Hierarchical Task Network (HTN) planner has been integrated within this module 105 to perform goal decomposition, although other techniques could be applied. The HTN (Hierarchial Task Network) planner “JSHOP2”, developed by D. Nau, Y. Cao, A. Lotem and H. Munoz-Avila from the University of Maryland, USA, has been used as a candidate planner during evaluation of this control system framework. Further information on this planner may be found in D. Nau et al, ‘SHOP2: An HTN Planning System’, Journal of Artificial Intelligence Research, Vol. 20, pp. 379-404, 2003, which is incorporated herein by reference. This planner is available for research purposes under the GNU GPL license agreement. It uses a structured language with a LISP-based syntax which was found to be an effective way of representing the selected scenarios to the Goal Decomposition module 105. A static domain file is provided which defines the relationships between a possible set of tasks and top-level goals which can be assigned by an operator. A problem definition file is generated by the module which defines the initial states and a target goal state to be achieved by the control system.

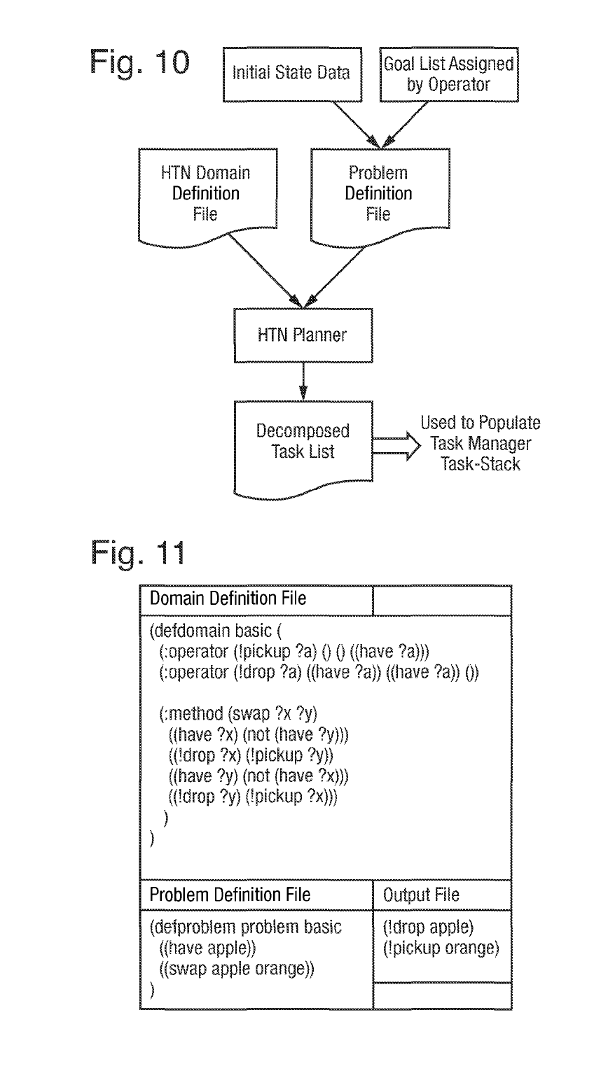

A simple example of an HTN planner input and output files are provided in FIG. 11. Referring to FIG. 11, this example provides two primitive tasks—‘pickup’ and ‘drop’—and also pre-conditions and post-conditions for a non-primitive function ‘swap’. The problem definition file provides initial states as ‘have apple’ and ‘not have orange’, and a goal state to ‘swap’ apple for orange. The HTN planner aims to represent the non-primitive function, ‘swap’ in terms of a set of primitive functions and finds that the solution is to ‘drop apple’ and ‘pickup orange’.

The problem definition file is updated each time the goal decomposition module is invoked by the Coordinator 100. The Coordinator 100 passes it relevant state and goal information from the State Estimator Module 125 to generate a problem definition file. A list of sub-tasks is output, e.g. by the Goal-Decomposition module, which can be handled by individual assets.

A non-HTN planner implementation can also be integrated into the Goal Decomposition module performing similar functionality but not using the Domain and Problem definition file mechanism. The interface between the Coordinator module and the Goal-Decomposition module may remain the same, with the Coordinator module inputting relevant state information and the Goal-Decomposition module returning a list of available tasks.

Task Assignment Module 115

Given a list of all the available tasks that may be performed to achieve a goal, the task deadlines and any preconditions, this module computes a set of task assignments for the team of assets. This assignment can be configured to minimise the mission duration or to maximise the asset utilisation. A number of known underlying task assignment algorithms have so far been implemented and evaluated within this module including:

Max Sum Assignment

Brute Force Assignment

Simulated Annealing (further information on which may be found in S. Kirkpatrick, C. Gelatt, M. Vecchi, ‘Optimization by Simulated Annealing’, Science, Vol. 220, pp. 671-680, 1983, which is incorporated herein by reference

Consensus Based Bundle Approach (CBBA) (further information on which may be found in H. Choi, L. Brunet, J. How, ‘Consensus-Based Decentralized Auctions for Robust Task Allocation’, IEEE Transactions on Robotics, Vol. 25, No. 4, pp. 912-926, August 2009, which is incorporated herein by reference)

Greedy Allocation

Mixed Integer Linear Programming (MILP)

Automated (PDDL) Planner Module 120

The Automated Planner Module 120 can be interfaced with an underlying PDDL (Planning Domain Definition Language) planner to compute plans given an initial state and goal state. PDDL was defined by McDermott during 1998 and provides a common language for representing planning problems based on the STRIPS (STanford Research Institute Problem Solver) planning language defined in 1971. Further information on PDDL may be found in M. Ghallab, ‘PDDL—The Planning Domain Definition Language’, Technical Report CVC TR-98-003/DCS TR-1165, Yale Center for Computational Vision and Control, New Haven, Conn., 1998 which is incorporated herein by reference. By providing a generic language for representing planning problems, the performance of compatible planning tools can be directly compared. As a result of the biennial International Planning Competition, there is a wide range of planning tools in development which are compatible with this language Further information on such tools may be found in D. McDermott, ‘The 1998 AI Planning Competition’, AI Magazine, Vol. 21, Iss. 2, pp. 35-55, 2000, which is incorporated herein by reference. Since it was first developed, there have been several extensions to this planning language with the most significant updates being noted in v2.1, further information upon which may be found in M. Fox & D. Long, ‘PDDL2.1: An Extension to PDDL for Expressing Temporal Planning Domains’, Journal of Artificial Intelligence Research, Vol. 20, pp. 61-124, 2003 which is incorporated herein by reference. This update enabled modeling of numerical fluents and durative actions within plans.

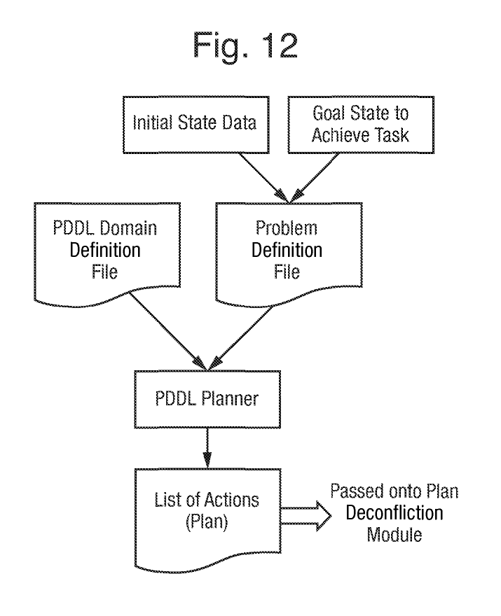

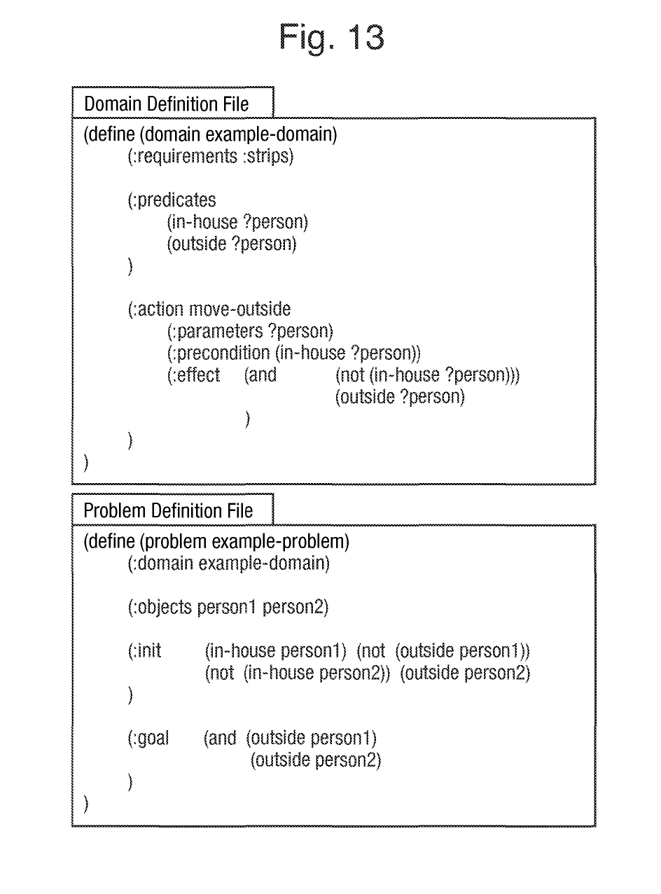

Referring to FIG. 12, a similar interface is used with the Planner Module 120 as with the HTN planner interfaced with the Goal-Decomposition module 105 described above. A static domain definition file defines the structure and names of facts and numerical variables that will be used to model the scenario. A list of available actions along with the action durations, preconditions and post-conditions is also provided. When the automated planner 120 is invoked, the Coordinator 100 generates a Problem Definition file using the current state data stored within the State Estimator Module 125 along with a target goal state. An example of the PDDL input files is provided in FIG. 13 where initially a person1 is inside a house and a person2 outside, with the simple assigned goal to move both outside the house. The output solution for this problem is ‘move-outside person-1’.

Generally, this type of planner is applied to single agent problems where the planner has complete control over the states in the model. The preferred framework of the present invention supports the features which enable this type of planner to be applied to multi-agent problems where there can be some uncertainty in the values of the world states during plan execution. During trials, this module was integrated with POPF (Partial Ordered Planner) developed by D. Long at University of Strathclyde, as it gave promising results. Further information on POPF may be found in A. Coles, A. Coles, M. Fox & D. Long, ‘Forward-Chaining Partial-Order Planning’, Proceedings of the Twentieth International Conference on Automated Planning and Scheduling, 2010, which is incorporated herein by reference. Using a generic planning language has the advantage that it is fairly straightforward to integrate an alternative planner without modifying the domain or problem definition files. The framework may also be used to evaluate a number of extensions to the PDDL language, such as PDDL+ and/or PPDDL (Probabilistic Planning Domain Definition Language). PDDL+ enables external processes and events to be modeled in the planning problem such that the planner can handle features that are out with its direct control. Further information on PDDL+ may be found in M. Fox & D. Long, ‘PDDL+: Modeling Continuous Time-Dependent Effects’, In Proceedings 3^{rd} International NASA Workshop on Planning and Scheduling for Space, 2002, which is incorporated herein by reference. PPDDL moves away from the deterministic planning problem and enables partial observability to be modeled for estimated state values or the changes to a state caused by executing an action. Further information on PPDDL may be found in H. Younes, M. Littman, D. Weissman & J. Asmuth, ‘The First Probabilistic Track of the International Planning Competition’, Journal of Artificial Intelligence Research, Vol. 24, pp. 851-887, 2005, which is incorporated herein by reference

Non-PDDL based planners can also be integrated into the Automated Planning module performing similar functionality but not using the Domain and Problem definition file mechanism. The interface between the Coordinator module and the Automated Planning module may remain the same, with the Coordinator module inputting relevant state information and Automated Planner module returning a list of actions to be completed by the asset.

State Estimator Module 125

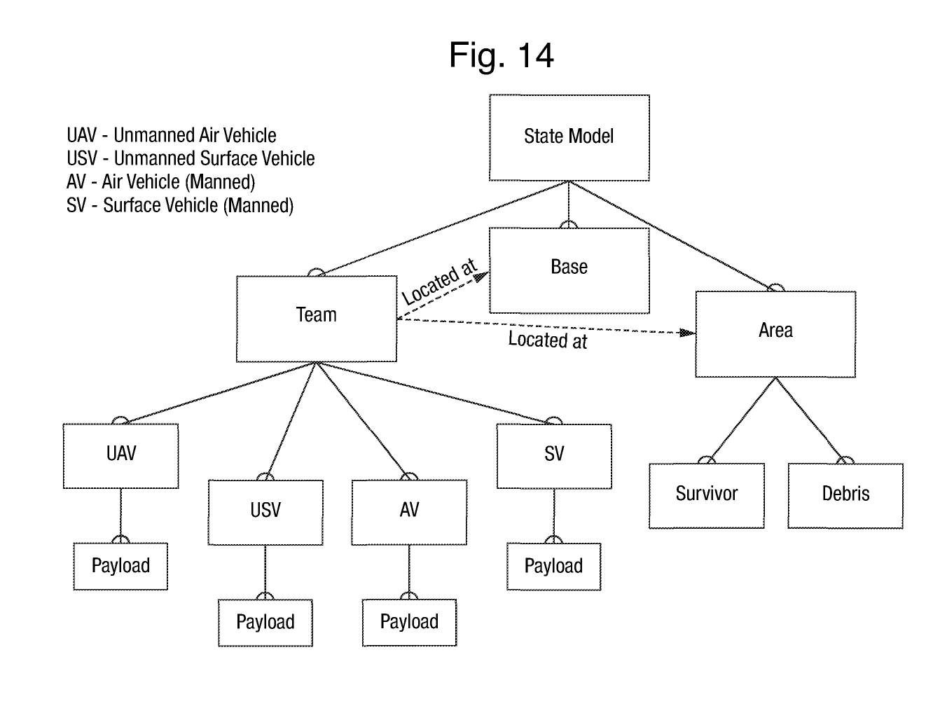

The State Estimator module 125 stores the asset's current beliefs about the world state. This will also include information about other assets in the team, such as their location and capabilities. Some of this data will be based on sensor measurements made by this asset and some will be the result of communicated state updates received from other assets. Data fusion techniques can be adopted to ensure that a common operating picture is maintained across the team of assets. The content of the state model will have to be tailored to a specific problem. An example of a state model for the search and rescue example mentioned above is shown in FIG. 14. In this case, the state mode contains information relating to scenario where a team of autonomous assets may be deployed to an area of operation, for example an area of open sea, to search for survivors of a boating accident.

The State Estimator 125 will have access to the platform interface layer sensors such that it can update the state model with data from on-board sensors. Any updates will also be relayed to other team members via the communication module.

Communication Interface Module 130

The Communication Interface module 130 shall interface to the system hardware via the Platform Interface layer 145. As new messages are received they are routed via the Coordinator 100 to the appropriate module. The types of communication handled by this module will include the following:

Top-level goals assigned by an operator which will be logged in the State Model

State updates relating either to data for another actor in a team or for an update to the environment

Task assignment negotiation

Plan steps that may be performed to provide deconfliction across the team

This module 130 supports sharing of UDP packets between assets within a team and with any operator control stations. A preferred implementation uses a CORBA-based mechanism to share information but, advantageously, through the modular nature of the framework in the present invention, alternative communication message structures may be implemented and integrated in the future, without an impact on the surrounding modules.

Deconfliction Module 135

When a plan is generated by an asset the plan steps are shared with other assets to make sure there are no position or resource conflicts. This module 135 stores future state information for other assets in a team which are relayed via the Communication module 130. If conflicts are identified, the conflicting assets will negotiate over which should modify their plans. Two example mechanisms that may be implemented to resolve conflicts are:

full re-plan may be required with additional state information used to define plan regions that should be avoided; and

minor repairs can be applied to the existing plan by changing some of the asset parameters, such as modifying the arrival time between plan actions or locally modifying the plan route.

Plan Executive 140

When a deconflicted plan is available for an asset to achieve its currently assigned tasks, the Plan Executive module 140 is responsible for linearly executing each action in the generated plan. This module will be integrated with the platform interface layer 145 and will issue commands to the asset actuators and sensors depending on the action requirements. For example, a move action may invoke the asset's drive mechanisms, or a sense action may require use of an asset sensor payload. Completed actions will result in updates to the information stored in the asset State Model, which will potentially also be shared with other assets if relevant.

Platform Interface Layer 145

This layer 145 is platform dependent but provides a standard set of interfaces such that the State Estimator 125, Plan Executive 140 and Communication Modules 130 can use the on-board sensors, actuators and communication link device respectively. This may either use direct functions calls to the hardware on-board an asset or may be via a behaviour-based planner which handles low-level operation of an asset. If the Goal-Based Planner is executing in a synthetic environment, this layer may also provide functionality to interface to relevant simulators.

1. A method of determining actions to be performed by a plurality of assets such that a predetermined task is performed, the method comprising:
receiving, by one or more task decomposition modules, task information, the task information specifying the predetermined task that is to be performed by the plurality of assets;
using the task information, determining, by the one or more task decomposition modules, a plurality of sub-tasks, the plurality of sub-tasks being such that if each of those sub-tasks were performed, the task specified by the task information would be performed;
using information relating to the plurality of assets and the determined sub-tasks, assigning, by one or more assignment modules, each of the sub-tasks to an asset; and
for each asset to which a sub-task has been assigned, and for each sub-task assigned to that asset, determining, at least in part by one or more planner modules, one or more actions;
wherein the one or more actions determined for an asset and for a sub-task assigned to that asset are such that, if those actions are performed by that asset, that asset would perform that sub-task.

2. A method according to claim 1, the method further comprising, for each asset to which a sub-task has been assigned, controlling, by one or more execution modules, that asset depending upon the one or more actions determined for that asset.

3. A method according to claim 2, wherein:
each of the assets comprises a respective execution module; and
for each asset to which a sub-task has been assigned, the execution module of that asset controls that asset depending upon the one or more actions determined for that asset.

4. A method according to claim 2, wherein:
the controlling of an asset is performed such that that asset performs each of the actions that have been determined for it; and
the method further comprises, performing, by each of the assets to which a sub-task has been assigned, the sub-tasks that have been assigned to that asset.

5. A method according to claim 1, wherein:
an algorithm implemented by a module is independent from an algorithm performed by a different type of module; and
interfaces between different types of modules are fixed interfaces.

6. A method according to claim 1, wherein:
each of the assets comprises a respective assignment module; and
the assigning comprises, for each asset, the assignment module of that asset identifying, depending upon one or more capabilities of that asset, one or more of the sub-tasks for assignment to that asset.

7. A method according to claim 1, wherein the assigning further comprises one or more communications being sent between two different task assignment modules to negotiate which sub-tasks are assigned to which asset.

8. A method according to claim 1, wherein:
each of the assets comprises a respective task decomposition module; and
each of the task decomposition modules performs the same task decomposition process as each of the other task decomposition modules such that the plurality of sub-tasks determined by each of the task decomposition modules is the same as the plurality of sub-tasks determined by each of the other task decomposition modules.

9. A method according to claim 1, wherein:
each of the assets comprises a respective planner module; and
for each asset to which a sub-task has been assigned, the planner module of that asset determines, for each sub-task assigned to that asset, one or more actions, the one or more actions being such that were those actions to be performed by that asset, that asset would perform that sub-task.

10. A method according to claim 1, wherein the determining one or more actions comprises performing, at least in part by one or more deconflictor modules, a deconfliction process to remove conflicts or inconsistencies between determined actions.

11. A method according to claim 10, wherein:
each of the assets comprises a respective deconflictor module; and
the determining one or more actions comprises one or more communications being sent between two different deconflictor modules to negotiate which actions to modify so as remove conflicts or inconsistencies between those actions.

12. A method according to claim 1, wherein:
the method further comprises determining, by a state estimator module, current state information for each of the assets; and
one or more of the determining the plurality of sub-tasks, assigning each of the sub-tasks to an asset, and determining one or more actions comprises using some or all of the determined state information.

13. A system for determining actions to be performed by a plurality of assets such that a predetermined task is performed, the system comprising:
one or more task decomposition modules, each task decomposition module configured to:
receive task information, the task information specifying the predetermined task that is to be performed by the plurality of assets; and
using the task information, determine a plurality of sub-tasks, the plurality of sub-tasks being such that if each of those sub-tasks were performed, the task specified by the task information would be performed;
one or more assignment modules, each assignment module being configured to, using information relating to the plurality of assets and the determined sub-tasks, assign each of the sub-tasks to an asset; and
one or more planner modules, each planner module being configured to, at least in part, determine, for each asset to which a sub-task has been assigned, and for each sub-task assigned to that asset, one or more actions;
wherein the one or more actions determined for an asset and for a sub-task assigned to that asset are such that if those actions are performed by that asset, that asset would perform that sub-task.

14. A machine readable storage medium having a computer program or plurality of computer programs encoded thereon such that when executed by one or more processors cause a method to be carried out, the method for determining actions to be performed by a plurality of assets such that a predetermined task is performed, the method comprising:
receiving, by one or more task decomposition modules, task information, the task information specifying the predetermined task that is to be performed by the plurality of assets;
using the task information, determining, by the one or more task decomposition modules, a plurality of sub-tasks, the plurality of sub-tasks being such that if each of those sub-tasks were performed, the task specified by the task information would be performed;
using information relating to the plurality of assets and the determined sub-tasks, assigning, by one or more assignment modules, each of the sub-tasks to an asset; and
for each asset to which a sub-task has been assigned, and for each sub-task assigned to that asset, determining, at least in part by one or more planner modules, one or more actions;
wherein the one or more actions determined for an asset and for a sub-task assigned to that asset are such that, if those actions are performed by that asset, that asset would perform that sub-task.

15. A machine readable storage medium according to claim 14, the method further comprising, for each asset to which a sub-task has been assigned, controlling, by one or more execution modules, that asset depending upon the one or more actions determined for that asset.

16. A machine readable storage medium according to claim 14, wherein:
each of the assets comprises a respective execution module; and
for each asset to which a sub-task has been assigned, the execution module of that asset controls that asset depending upon the one or more actions determined for that asset;
each of the assets comprises a respective assignment module; and
the assigning comprises, for each asset, the assignment module of that asset identifying, depending upon one or more capabilities of that asset, one or more of the sub-tasks for assignment to that asset;
each of the assets comprises a respective task decomposition module; and
each of the task decomposition modules performs the same task decomposition process as each of the other task decomposition modules such that the plurality of sub-tasks determined by each of the task decomposition modules is the same as the plurality of sub-tasks determined by each of the other task decomposition modules;
each of the assets comprises a respective planner module; and
for each asset to which a sub-task has been assigned, the planner module of that asset determines, for each sub-task assigned to that asset, one or more actions, the one or more actions being such that were those actions to be performed by that asset, that asset would perform that sub-task.

17. A machine readable storage medium according to claim 14, wherein:
the controlling of an asset is performed such that that asset performs each of the actions that have been determined for it; and
the method further comprises, performing, by each of the assets to which a sub-task has been assigned, the sub-tasks that have been assigned to that asset.

18. A machine readable storage medium according to claim 14, wherein the determining one or more actions comprises performing, at least in part by one or more deconflictor modules, a deconfliction process to remove conflicts or inconsistencies between determined actions.

19. A machine readable storage medium according to claim 14, wherein:
each of the assets comprises a respective deconflictor module; and
the determining one or more actions comprises one or more communications being sent between two different deconflictor modules to negotiate which actions to modify so as remove conflicts or inconsistencies between those actions.

20. A machine readable storage medium according to claim 14, wherein:
the method further comprises determining, by a state estimator module, current state information for each of the assets; and
one or more of the determining the plurality of sub-tasks, assigning each of the sub-tasks to an asset, and determining one or more actions comprises using some or all of the determined state information.
